(19) United States
(12) Patent Application Publication
(10) Pub. No.: US 2023/0247081 A1
(43) Pub. Date: Aug. 3, 2023

(54) DECLARATIVE RENDERING OF HYPERTEXT TRANSFER PROTOCOL HEADERS

(71) Applicant: salesforce.com, inc., San Francisco, CA (US)

(72) Inventors: Benjamin Thomas Irwin, Bellevue, WA (US); Wu Liu, San Francisco, CA (US); Sai Prameela Konduru, San Francisco, CA (US); Kun-Tao Chiang, San Francisco, CA (US); David Tee, San Francisco, CA (US); Donhoon Lee, Bothell, WA (US); Vaibhav Bansal, San Francisco, CA (US)

(21) Appl. No.: 17/589,788

(22) Filed: Jan. 31, 2022

(51) Int. Cl. H04L 67/02; G06F 16/957

(52) U.S. Cl. CPC H04L 67/02; G06F 16/9577

(57) ABSTRACT

Approaches for rendering of hypertext transfer protocol (HTTP) headers are disclosed. A method may include receiving a partial HTTP response message generated in response to an HTTP request message. The partial HTTP response message may include an indication of an HTTP header configuration based on one or more security parameters. The method may include retrieving the HTTP header configuration based on the indication of the HTTP header configuration. The HTTP header configuration may indicate one or more HTTP header parameters and one or more header rendering actions associated with the one or more HTTP header parameters. The method may include generating a complete HTTP response message that may include the partial HTTP response message modified by the one or more HTTP header parameters based on the one or more header rendering actions. The method may include transmitting the complete HTTP response message.

### FIELD OF TECHNOLOGY

The present disclosure relates generally to database systems and data processing, and more specifically to declarative rendering of hypertext transfer protocol (HTTP) headers.

### BACKGROUND

A cloud platform (i.e., a computing platform for cloud computing) may be employed by many users to store, manage, and process data using a shared network of remote servers. Users may develop applications on the cloud platform to handle the storage, management, and processing of data. In some cases, the cloud platform may utilize a multi-tenant database system. Users may access the cloud platform using various user devices (e.g., desktop computers, laptops, smartphones, tablets, or other computing systems, etc.).

In one example, the cloud platform may support customer relationship management (CRM) solutions. This may include support for sales, service, marketing, community, analytics, applications, and the Internet of Things. A user may utilize the cloud platform to help manage contacts of the user. For example, managing contacts of the user may include analyzing data, storing and preparing communications, and tracking opportunities and sales.

In some cloud platform scenarios, the cloud platform, a server, or other device may render HTTP headers for a web page. However, methods for rendering such HTTP headers may be deficient.

### BRIEF DESCRIPTION OF THE DRAWINGS

FIG. 1 illustrates an example of a for data processing system that supports declarative rendering of HTTP headers in accordance with examples as provided herein.

FIG. 2 illustrates an example of a system that supports declarative rendering of HTTP headers in accordance with examples as provided herein.

FIG. 3 illustrates an example of a system that supports declarative rendering of HTTP headers in accordance with examples as provided herein.

FIG. 4 illustrates an example of a process flow that supports declarative rendering of HTTP headers in accordance with examples as provided herein.

FIG. 5 shows a block diagram of an apparatus that supports declarative rendering of HTTP headers in accordance with examples as provided herein.

FIG. 6 shows a block diagram of an HTTP Response Manager that supports declarative rendering of HTTP headers in accordance with examples as provided herein.

FIG. 7 shows a diagram of a system including a device that supports declarative rendering of HTTP headers in accordance with examples as provided herein.

FIGS. 8 through 10 show flowcharts illustrating methods that support declarative rendering of HTTP headers in accordance with examples as provided herein.

### DETAILED DESCRIPTION

HTTP headers allow a client or a server to transmit additional information alongside a HTTP request or response (e.g., request headers or response headers). Such additional information may include information used for various purposes, one of which may include security associated with web pages. In some cases, security HTTP headers may be sent by one or more applications in a relatively uniform fashion, which may be performed in application code. However, such approaches may include several issues. In a single application or service, header rendering can become fragmented and it can be difficult to ascertain the full set of rendered headers. In an environment with multiple applications or services, fragmentation may also occur across multiple coding languages or frameworks and such approaches may suffer a lack of co-locality if header rendering is spread across multiple files or libraries. Separate implementations may deviate from one another and use multiple updates across the various implementations. Further, those not familiar with the code may not understand which headers are rendered or how they are rendered without lengthy, difficult examination of the code and reference to separate documentation.

To reduce or eliminate such issues, a server, rendering engine, or other element or entity may load or maintain a set of policy configurations. Each policy configuration may define a collection of HTTP response headers and the circumstances under which they may be set. Such policies may be encoded in easily-read configuration files (e.g., human-readable configuration files, which may be stored in various formats, such as markup language (e.g., YAML or JSON). A policy may be selected via a policy-id, which may be chosen by the application based on the request context. For example, a server may prepare an HTTP response to an HTTP request. A service, server, application, or other implementation of the current subject matter may intercept a partial HTTP response and retrieve an HTTP header policy based on the policy id. The service, server, application, or other implementation may then render the HTTP headers based on the retrieved policy associated with the policy id. In this way, HTTP headers may be rendered according to uniform policies that meet one or more priorities (e.g., security, performance, other considerations, or any combination thereof) while also providing easily understandable characteristics of such policies. Further, such approaches also provide for a unified system for rendering HTTP headers that avoid technical problems present in other approaches that result in fragmented and inconsistent header policies across different elements of a data processing platform or cloud computing platform.

The subject matter described herein may further manage sub-header parameters associated with the HTTP headers. For example, an HTTP header such as Content-Security-Policy may include or be associated with one or more sub-headers, and the subject matter described herein may include rendering one or more sub-headers. Further, security parameters (e.g., security parameters upon which an indication of an HTTP header configuration may be based), cookies, uniform resource locators (URLs), tokens, browsers, or any combination thereof may be factors for selecting an HTTP header policy. For example, web pages, login statuses, or browsers may imply or involve the use of one or more security policies. For example, a web page used to login to a banking account may imply different security settings than a page associated with a public-facing listing of frequently asked questions.

Aspects of the disclosure are initially described in the context of an environment supporting an on-demand database service. Aspects of the disclosure may be then described in relation to system diagrams and a process flow. Aspects of the disclosure are further illustrated by and described with reference to apparatus diagrams, system diagrams, and flowcharts that relate to declarative rendering of HTTP headers.

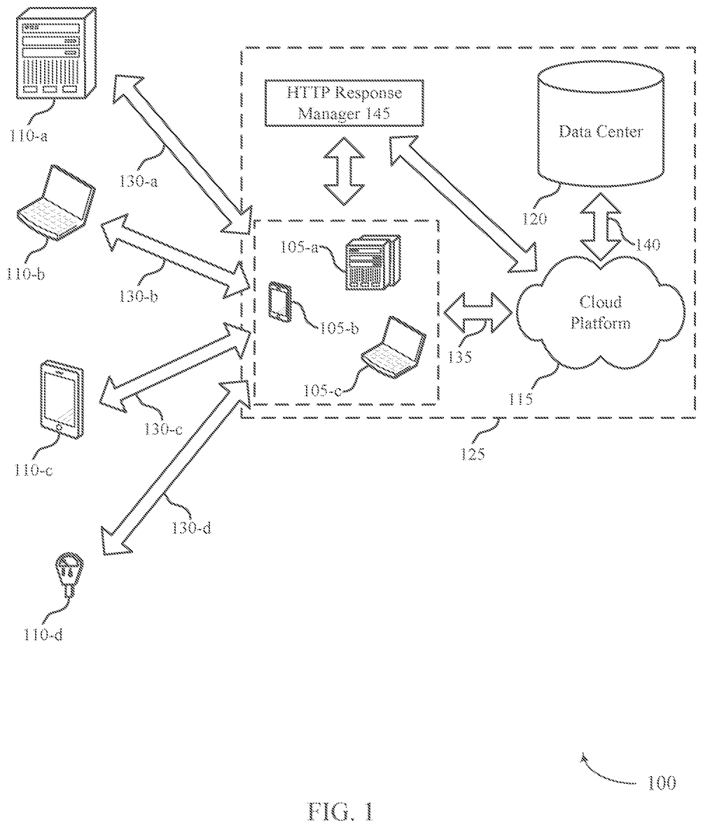

FIG. 1 illustrates an example of a system 100 for cloud computing that supports declarative rendering of HTTP headers in accordance with various aspects of the present disclosure. The system 100 includes cloud clients 105, contacts 110, cloud platform 115, and data center 120. Cloud platform 115 may be an example of a public or private cloud network. A cloud client 105 may access cloud platform 115 over network connection 135. The network may implement transfer control protocol and internet protocol (TCP/IP), such as the Internet, or may implement other network protocols. A cloud client 105 may be an example of a user device, such as a server (e.g., cloud client 105-a), a smartphone (e.g., cloud client 105-b), or a laptop (e.g., cloud client 105-c). In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple contacts 110. The interactions 130 may include communications, opportunities, purchases, sales, or any other interaction between a cloud client 105 and a contact 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to certain applications, data, and database information within cloud platform 115 based on the associated security or permission level, and may not have access to others.

Contacts 110 may interact with the cloud client 105 in person or via phone, email, web, text messages, mail, or any other appropriate form of interaction (e.g., interactions 130-a, 130-b, 130-c, and 130-d). The interaction 130 may be a business-to-business (B2B) interaction or a business-to-consumer (B2C) interaction. A contact 110 may also be referred to as a customer, a potential customer, a lead, a client, or some other suitable terminology. In some cases, the contact 110 may be an example of a user device, such as a server (e.g., contact 110-a), a laptop (e.g., contact 110-b), a smartphone (e.g., contact 110-c), or a sensor (e.g., contact 110-d). In other cases, the contact 110 may be another computing system. In some cases, the contact 110 may be operated by a user or group of users. The user or group of users may be associated with a business, a manufacturer, or any other appropriate organization.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including—but not limited to—client-server systems, mobile device systems, and mobile network systems. In some cases, cloud platform 115 may support CRM solutions. This may include support for sales, service, marketing, community, analytics, applications, and the Internet of Things. Cloud platform 115 may receive data associated with contact interactions 130 from the cloud client 105 over network connection 135, and may store and analyze the data. In some cases, cloud platform 115 may receive data directly from an interaction 130 between a contact 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or an interaction 130 between a contact 110 and the cloud client 105. Data center 120 may utilize multiple redundancies for security purposes. In some cases, the data stored at data center 120 may be backed up by copies of the data at a different data center (not pictured).

Subsystem 125 may include cloud clients 105, cloud platform 115, and data center 120. In some cases, data processing may occur at any of the components of subsystem 125, or at a combination of these components. In some cases, servers may perform the data processing. The servers may be a cloud client 105 or located at data center 120.

A contact 110 may wish to access information stored at the subsystem 125 or any of the components within the subsystem 125. In some examples, a contact 110 may utilize a browser or some other platform for retrieving information from the subsystem 125 via a webpage over a network (e.g., the Internet). To retrieve the information, the contact 110 may send an HTTP request message to an entity within the subsystem 125. In response to this HTTP request message from a contact 110, a client 105 or other entity within the subsystem 125 may generate a partial HTTP response message. The HTTP response manager 145 (which may or may not be part of or associated with the cloud platform 115 or other depicted elements), may intercept or otherwise receive the partial HTTP response message from the client 105. The partial HTTP response message may be generated (e.g., at the cloud platform 115) in response to the HTTP request message transmitted by the contact 110. The partial HTTP response message may include an indication of an HTTP header configuration based on one or more security parameters (e.g., based on the type or location of the information being retrieved by the contact 110). The HTTP response manager 145 may retrieve a HTTP header configuration based on the indication of the HTTP header configuration. The HTTP header configuration may indicate one or more HTTP header parameters and one or more header rendering actions associated with the one or more HTTP header parameters. The HTTP response manager 145 may generate a complete HTTP response message that may include the partial HTTP response message modified by the one or more HTTP header parameters based on the one or more header rendering actions. The HTTP response manager 145 may transmit the complete HTTP response message to a user device (e.g., to a contact 110 that originated the HTTP request message).

Some approaches for setting headers (e.g., setting headers from code) face technical limitations. For example, such approaches may suffer a lack of co-locality (e.g., when header rendering may be spread across many files or libraries). Such a lack of co-locality may mean that the same headers may be rendered differently across files, libraries, or implementations, or that different headers may be rendered even though the same headers should be rendered across files, libraries, or implementations. Further, the source code may deviate over time from documentation that is not continually updated across such files, libraries, or implementations. Further, such fragmentation may occur in a single application or across multiple applications, and it may be difficult to ascertain, determine, or identify a full set of rendered headers. Additionally or alternatively, such approaches may involve considerable effort to determine characteristics or behavior of HTTP headers (e.g., which headers may be set under which circumstances). Other people (e.g., people who are not directly involved in programming or not involved in programming the headers or code, such as information security officers that may review security headers, for example) may resort to additional documentation to understand which headers the software will render or how those headers may be rendered.

The subject matter described herein addresses such technical problems present in some approaches for setting headers. The subject matter described herein may resolve problems involving a lack of co-locality, fragmentation, or both, by defining collections of HTTP headers and the circumstances under which they may be set. For example, the subject matter described herein may provide for policies or policy configurations that may indicate one or more HTTP headers and one or more rendering actions associated with the one or more HTTP headers. Such policies or configurations may be encoded in markup files (e.g., YAML or JSON) that may be easily readable by programmers and non-programmers alike. These policies or configurations may be stored in a central repository, and may be accessed in multiple ways (e.g., an invocable Java library, a filter extension, such as a C++/WASM filter extension, that may be loaded into a proxy, through other methods, or any combination thereof). Further, policy identifiers may be uniquely identifiable. If named wisely, software developers may easily search code for such a token and discover which requests will trigger which policies. Such policy definitions or configurations may be self-documenting in a way that other approaches are not. For example, when a new feature requires additional trusted sites, a definition of policy areas allows the developer to have confidence that such a change may be targeting a reasonable minimal set of pages.

Issues for non-developers (such as those described herein) may also be improved or resolved. For example, given a document which describes when different policies are selected, the non-developer may easily find an appropriate policy configuration. With no other context they can know why certain headers were rendered and they can propose changes independently. Such policy definitions may be a documentation and communication tool for the entire organization.

For example, a developer may establish a central repository or database of HTTP header policies or configurations. Each policy or configuration may include one or more HTTP headers and associated rendering actions. The developer may further define or set security parameters associated with web pages that a user may access, and based on those security parameters, may select a policy configuration that may be used in association with such web pages and may include or associate a policy identifier with the webpage. Thus, when a user submits an HTTP request for a web page, a server or other entity may create a partial HTTP response, and a rendering entity (e.g., the HTTP response manager 145) may recognize the policy identifier associated with the HTTP request for the web page, retrieve the associated policy based on the policy identifier, and generate a complete HTTP response (e.g., by rendering the headers associated with the policy) based on the partial HTTP response and the information (e.g., header identifications, header rendering actions, or both) from the policy. In this way, a centralized repository for HTTP header policies that promotes uniformity and is easily analyzed may be used to render HTTP headers for webpages.

It should be appreciated by a person skilled in the art that one or more aspects of the disclosure may be implemented in a system 100 to additionally or alternatively solve other problems than those described above. Further, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

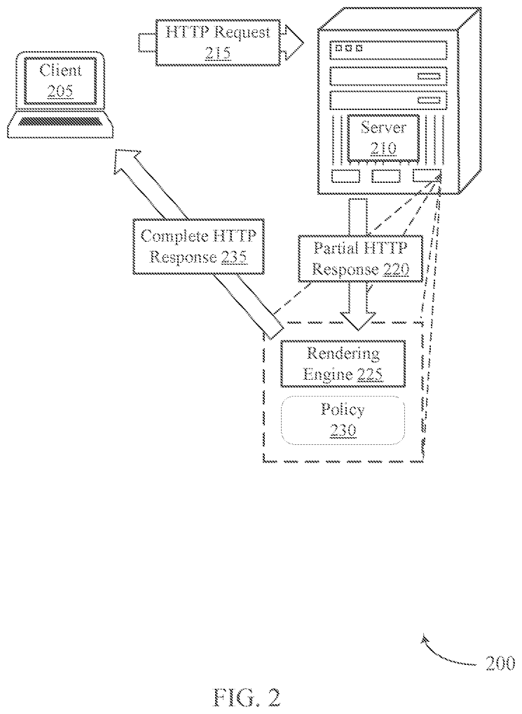

FIG. 2 illustrates an example of a system 200 that supports declarative rendering of HTTP headers in accordance with examples as provided herein. The system 200 may include a client 205 and a server 210. The server 210 may run, configure, or otherwise support a rendering engine 225 that may perform functions or operations for rendering HTTP headers as described herein. Though the rendering engine 225 may be depicted or described as being associated with the server 210 or other entity in some examples, the rendering engine may be associated with a different entity (e.g., a cloud platform, another server, or another entity) or may be an independent entity (e.g., a dedicated machine for rendering HTTP headers).

In some examples, the client 205 may transmit an HTTP request 215 to the server 210. The client 205 may transmit such an HTTP request 215 so that the client 205 may access a webpage or other resources. The HTTP request may be associated with a webpage that may offer one or more functions, operations, content, or any combination thereof to the client 205 (e.g., a login function, an information retrieval function, sensitive or private information, or any combination thereof). Such functions, operations, or information may imply or be associated with one or more security scenarios that may themselves imply or be associated with one or more security measures. For example, if a user at the client 205 wants to login to a webpage that contains private information, one or more security parameters or settings may be associated with the login function, private information, or both.

As such, the server 210 may receive and process the HTTP request 215 to generate the partial HTTP response 220. The partial HTTP response 220 may be partial in that in may not may have a complete set of rendered headers, or may be otherwise different as compared to a complete HTTP response (e.g., complete HTTP response 220). As discussed herein, the server 210 may further determine or select security parameters to be associated with the complete HTTP response 235 that is to be transmitted to the client 205 (e.g., based on a function, operation, or information associated with the webpage or the HTTP request 215). Based on these security parameters, the server 210 may therefore indicate a policy 230 that is to be used for rendering the headers that are to be ultimately included in the complete HTTP response 235. Such an indication may be provided within or alongside the partial HTTP response 220, or may be transmitted separately to the rendering engine 225.

The rendering engine 225 may receive or intercept the partial HTTP response 220 from the server 210. The rendering engine 225 may process the partial HTTP response 220, including the indication of the policy 230 that the rendering engine is to use to render the headers and produce the complete HTTP response 235. In some examples, the policy 230 may be stored with the rendering engine 225, with the server 210, or may be stored at a separate storage location. The rendering engine 225 may retrieve the policy 230 based on the indication of the policy 230 that is included with the partial HTTP response 220 or that may be received separately from the server 210. For example, the indication of the policy 230 may indicate a policy identifier, and the rendering engine 225 may retrieve the policy 230 based on the policy identifier. As used herein, the terms policy, HTTP header policy, or similar terms may also be referred to as an HTTP header configuration.

In some examples, the policy 230 may include one or more unified rulesets for rendering HTTP headers. For example, the policy 230 may include an indication of one or more HTTP headers that is to be placed, modified, or removed. The policy 230 may further include one or more circumstances under which such HTTP headers is to be placed, modified, or removed. For example, the policy 230 may include a number of different headers, and one or more actions to be taken for each header. In such an example, the policy 230 may dictate that the first header is to be set, the second header is to be unset, and the third header is to be set if empty (e.g., if the designated header in the partial HTTP response 220 may be empty, it may be set by the rendering engine 225). Other actions or combinations of actions may be possible (e.g., as described herein), and may be contemplated by the subject matter described herein.

In some examples, the policy 230 may be stored in a markup format (e.g., a YAML Ain't Markup Language (YAML) format, a JavaScript Object Notation (JSON) format, or other markup format). By using such formats, the policy 230 may be easily readable by a human (e.g., a developer writing code or a non-developer tasked with reviewing code to determine compliance with security procedures or operations). In some examples, the policy 230 may be initially stored in a markup format (e.g., in a repository for multiple policies 230), but may subsequently or alternatively be stored in another format for further retrieval (e.g., by other entities), modification, updating, or other procedures. For example, a policy repository may store policy templates which may then be populated with additional data (e.g., structured data) that may be retrieved from another source (e.g., a database).

The rendering engine 225 may then perform the one or more rendering actions on the one or more indicated HTTP headers in the partial HTTP response 220 (e.g., thereby creating the complete HTTP response 235). Additionally or alternatively, the rendering engine 225 may use the information to create a new response as opposed to modifying the partial HTTP response 220, though both options may be possible and contemplated by the subject matter described herein. The complete HTTP response 235 may include the one or more indicated headers from the policy 230, and may have performed the rendering actions on the one or more indicated headers (e.g., added, modified, or removed headers or parameters of such headers) as described in the policy 230. The rendering engine 225 may transmit the complete HTTP response 235 to the client 205. Additionally or alternatively, the rendering engine 225 may transmit the complete HTTP response 235 to the server 210, which may then transmit the complete HTTP response 235 to the client 205. Optionally, the server 210 may modify one or more parameters or content items of the complete HTTP response 235 before transmitting to the client 205.

In this way, the rendering engine 225 may provide a central point for rendering HTTP headers (optionally with a focus on security headers) using rulesets defined by the policy 230, instead of the headers being set by application code (e.g., as found in other approaches). Further, such approaches may reduce fragmentation, both in a single-application context as well as across a multiple-application context or in a micro-services context, thereby reducing or avoiding forking of functional implementations and increasing consistency. In addition, such approaches may allow for searching for tokens associated with a policy (e.g., policy 230), which may allow for efficient discovery of which requests may trigger which policies.

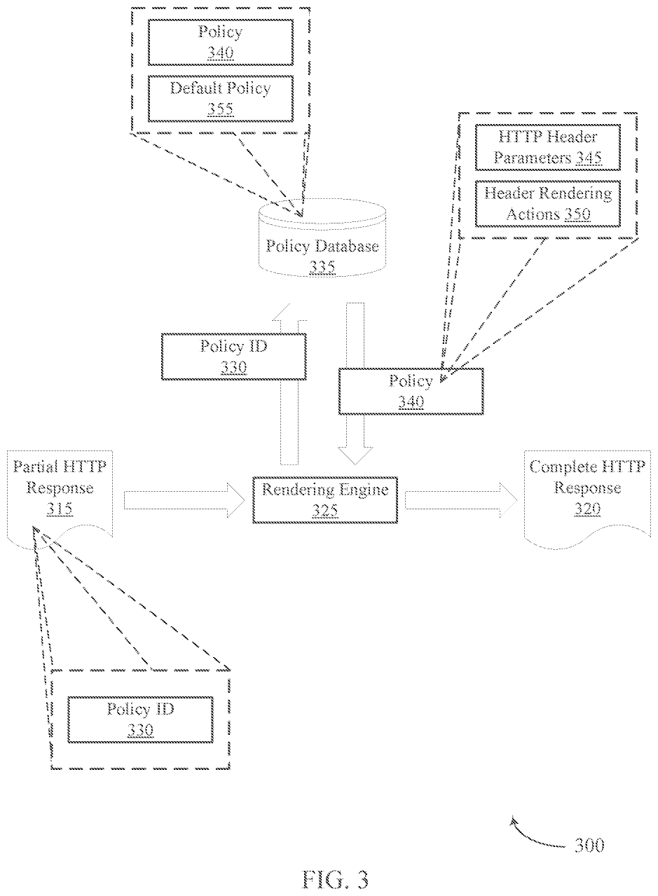

FIG. 3 illustrates an example of a system 300 that supports declarative rendering of HTTP headers in accordance with examples as provided herein. The system 300 may include a rendering engine 325 that may render HTTP headers according to the subject matter described herein. The rendering engine 325 may receive the partial HTTP response 315 (e.g., from a server or other entity that may have received an HTTP request from a client and may have generated the partial HTTP response 315). The partial HTTP response 315 may include or be associated with a policy ID 330 that may indicate a policy that is to be used for rendering one or more HTTP headers for a webpage or other resource requested by a client or for the complete HTTP response 320.

In some examples, the partial HTTP response 315, the initial HTTP request made by a client, or both, may be associated with one or more factors that may influence the selection of a policy 340 (and the selection of the policy ID 330 that is to be included or associated with the partial HTTP response 315). For example, the selection of the policy 340 may be influenced by one or more security parameters, security scenarios, page functions (e.g., login, data retrieval, data display, password establishment or reset, identify verification, providing or retrieving credentials, other functions, or any combination thereof), page contents (e.g., public contents, private contents, contents of a format, type, or security level, or any combination thereof), one or more cookies, one or more uniform resource locators (URLs), one or more tokens (e.g., OAuth tokens or other tokens, such as security tokens or authorization tokens), a browser, an operating system, or any combination thereof, any or all of which may be associated with the partial HTTP response 315 or the initial HTTP request made by a client. For example, headers (e.g., security headers) may be set or modified differently based on a browser that may be being used by a client, as different browsers may perform differently from one another and it may be desirable to render one or more HTTP headers differently to accommodate such performance differences. For example, one browser may not support one or more HTTP headers, while another browser may support them. Such information about a browser may be obtained from a request header (e.g., a User-Agent request header) or a hint header, such as a Sec-CH-UA client hint header.

In some examples, the selection or identification of policies 340 may be influenced or determined based on a page or page type for which access is being requested through the initial HTTP request transmitted by a client. Such pages or page types could include a login page, a home page, a detail page, a page with sensitive or private information, a page associated with one or more applications, or other pages, page types, or considerations associated with one or more pages. As can be appreciated, different pages may imply or be associated with different levels or configurations for security or other considerations that may influence the selection of a policy 340 for rendering the HTTP headers in a response transmitted to the client.

As described herein, the rendering engine 325 may obtain the policy ID 330 and, based on the policy ID 330, retrieve the indicated policy 340. In some examples, such a retrieval may be based on a matching process between the policy ID 330 and the matching policy 340. For example, a policy ID 330 may be a unique identifier (e.g., a name, a number, a security scenario, another relevant identifier, or any combination thereof), and the rendering engine 325 may match the policy ID 330 with the indicated policy 340, which may be associated with the policy ID 330.

In some examples, the various policies 340 available to the rendering engine 325 may be stored in a policy database 335 or other storage. For example, the various policies 340 may be stored in a markup file format (e.g., YAML or JSON) in a database. However, the policies 340 may not be stored indefinitely in a markup file format. For example, a policy repository may store the policies in a different format (e.g., as part of an implementation with different technology stacks). For example, the use of the policies 340 and the general approaches described herein may be implemented or applied to an invocable Java library for ease of access. Additionally or alternatively, the use of the policies 340 and the general approaches described herein may be implemented or applied to a C++/WebAssembly (WASM) filter extension that may optionally be loaded into a proxy (e.g., an envoy proxy).

As described herein, the policies 340 may include one or more HTTP header parameters 345, one or more header rendering actions 350, or any combination thereof An HTTP header parameter may identify an HTTP header that is to be added, modified, or removed in some way based on the policy 340. Additionally or alternatively, an HTTP header parameter may represent or be associated with one or more aspects of an HTTP header, such as an attribute value). For example, the policies 340 may include one or more indications of a sub-header or attribute (e.g., one or more HTTP header parameters) that may be added, modified, or removed based on the policy (e.g., based on the one or more header rendering actions 350). Additionally or alternatively, the policy 340 may include one or more sub-header parameters that may be associated with one or more of the one or more HTTP header parameters 345. Additionally or alternatively, the policy 340 may include one or more sub-header rending actions that may be associated with the one or more sub-header parameters. In some examples, such sub-header parameters, sub-header rendering actions, or both, may be used to modify the partial HTTP response 315 to produce the complete HTTP response 320.

In some examples, the policy 340 may identify one or more HTTP headers and particular actions that is to be performed in association with those headers. Such actions may include, but may be not limited to the following: a set action (e.g., that may set or overwrite a header or attribute value), a set-if-empty action (e.g., that may set a header or attribute value if the header or attribute value may be not set), a merge action (e.g., that may merge a current value of a header or attribute with a string), an unset action (e.g., that may remove a header if it us set), an add action (e.g., that may add another copy of a header, which may be useful for headers with multiplicity, such as a Set-Cookie header), or any combination thereof

In some examples, the partial HTTP response 315 may not include an indication of a policy 340 to be used. In such a case, the rendering engine 325 may determine to use or select a default policy 355 to be used in such a case. For example, it may be determined that if no policy 340 may be indicated in the partial HTTP response 315, that the default policy 355 is to be used, since the default policy 355 may provide a level of security or configuration that may be acceptable or application (e.g., across a range of circumstances, pages, clients, or other elements). Additionally or alternatively, a partial HTTP response 315 may indicate that use of the default policy 355 (e.g., by that may indicate a policy ID 330 associated with the default policy 355 or by that may indicate through a flag or other indication that a default policy 355 is to be used). In some examples, a lack of an indication of a policy ID 330 may itself be considered an indication to use or apply a default policy 355 for rendering of HTTP headers.

In some examples, the rendering engine 325 may be implemented as a proxy. For example, the rendering engine 325 may receive or intercept the partial HTTP response 315 (e.g., from a server or other entity associated with preparing a response to an HTTP request transmitted by a client). After processing the partial HTTP response 315, the rendering engine 325 may produce the complete HTTP response 320 by modifying the partial HTTP response 315, or may generate a new HTTP response to produce the partial HTTP response 315 (e.g., based on information associated with or included in (or both) the partial HTTP response 315. Further, the rendering engine 325 may transmit the rendering engine 325 directly to the client that initially transmitted the HTTP request, or may transmit the complete HTTP response 320 to the entity that initially generated the partial HTTP response 315 or received the initial HTTP request made by the client.

Though the policy database 335 may be depicted as storing the various policies 340 (including the default policy 355) available to the rendering engine 325, the policies may be stored, retrieved, or accessed from other locations. For example, the policies may be co-located with the rendering engine 325 or another entity (e.g., a server that initially receives the HTTP request from the client). Further, the policies 340 may be stored in different places (either temporarily or permanently based on different implementations). Further, such storage may imply or employ the use of different data formats to store the information included in the policies 340 (e.g., markup languages or other data formats).

One of the many advantages of storing the policies 340 in the policy database 335 or other storage may be that updating the policies 340 may be simplified and uniformity may be increased or assured across a single or multiple applications. In some examples, the rendering engine 325 or other entity may receive a request (e.g., an update request) to update one or more policies 340, to add a new policy 340, to remove a policy 340, or any combination thereof. In this way, the policies 340 may be adjusted for changing circumstances or priorities, and uniformity of these changes may be increased or assured.

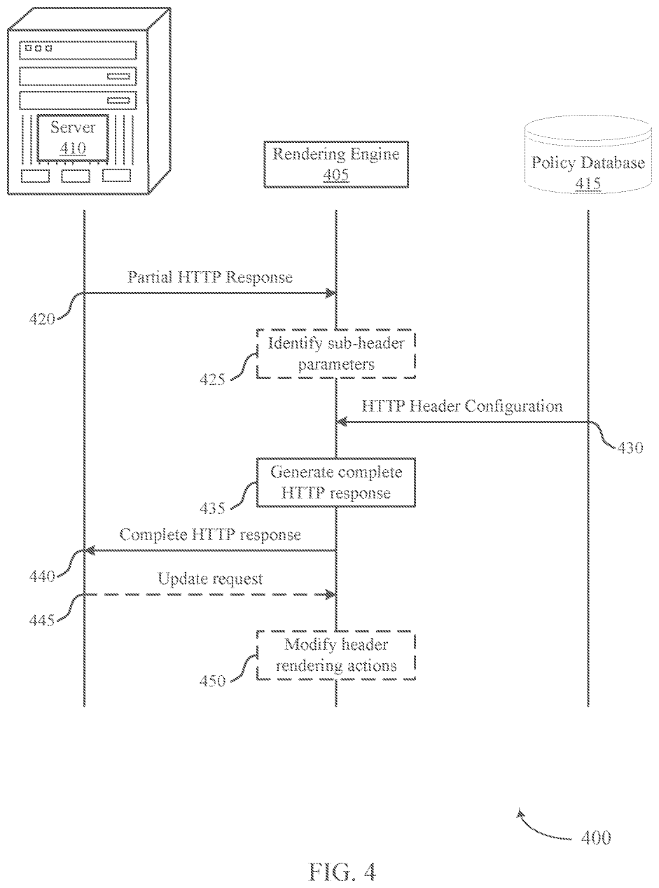

FIG. 4 illustrates an example of a process flow 400 that supports declarative rendering of HTTP headers in accordance with examples as provided herein. The process flow 400 may implement various aspects of the present disclosure described with reference to FIGS. 1-3. The process flow 400 may include a rendering engine 405, a server 410, and a policy database 415, which may be examples of similarly named elements as described with reference to FIGS. 1-3.

In the following description of the process flow 400, the operations between the rendering engine 405, server 410, and policy database 415 may be performed in different orders or at different times. Some operations may also be left out of the process flow 400, or other operations may be added. Although the rendering engine 405, server 410, and policy database 415 may be shown performing the operations of the process flow 400, some aspects of some operations may also be performed by other elements of the process flow 400 or by elements that may not be depicted in the process flow, or any combination thereof

At 420, the rendering engine 405 may receive a partial HTTP response message generated in response to an HTTP request message transmitted by a user device, and the partial HTTP response message may include an indication of an HTTP header configuration based on one or more security parameters associated with the HTTP request message. In some examples, the one or more security parameters may be associated with one or more page functions associated with the partial HTTP response message. In some examples, the indication of the HTTP header configuration may be included in the partial HTTP response message based on one or more cookies associated with the partial HTTP response message, one or more URLs associated with the partial HTTP response message, one or more tokens, a browser associated with the partial HTTP response message, or any combination thereof. In some examples, the indication of the HTTP header configuration may include an HTTP header configuration identifier.

At 425, the rendering engine 405 may identify, based on the HTTP header configuration, one or more sub-header parameters associated with the one or more HTTP header parameters and one or more sub-header rendering actions associated with the one or more sub-header parameters. In some examples, the complete HTTP response message may include the partial HTTP response message modified by the one or more sub-header parameters based on the one or more sub-header rendering actions.

At 430, the rendering engine 405 may retrieve the HTTP header configuration based on the indication of the HTTP header configuration. In some examples, the HTTP header configuration may indicate one or more HTTP header parameters and one or more header rendering actions associated with the one or more HTTP header parameters. In some examples, retrieving the HTTP header configuration may include retrieving a default HTTP header configuration based on the indication of the HTTP header configuration including an indication of the default HTTP header configuration. In some examples, retrieving the HTTP header configuration may include performing a matching process between the HTTP header configuration identifier and the HTTP header configuration. In some examples, the HTTP header configuration may be stored in a markup file format.

At 435, the rendering engine 405 may generate a complete HTTP response message that may include the partial HTTP response message modified by the one or more HTTP header parameters based on the one or more header rendering actions. In some examples, the one or more header rendering actions comprise a set action, a set-if-empty action, a merge action, an unset action, an add action, or any combination thereof

At 440, the rendering engine 405 may transmit the complete HTTP response message to the user device.

At 445, the rendering engine 405 may receive an HTTP header configuration update request that may include an indication of one or more modifications to at least one of the one or more header rendering actions.

At 450, the rendering engine 405 may modify the one or more header rendering actions based on the HTTP header configuration update request.

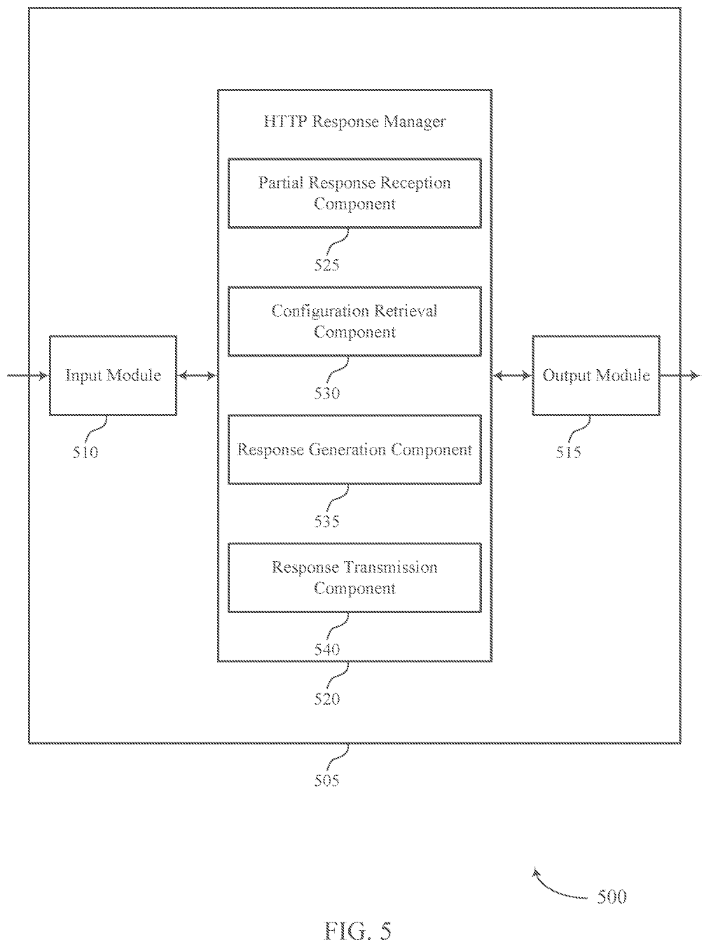

FIG. 5 shows a block diagram 500 of a device 505 that supports declarative rendering of HTTP headers in accordance with examples as provided herein. The device 505 may include an input module 510, an output module 515, and an HTTP Response Manager 520. The device 505 may also include a processor. Each of these components may be in communication with one another (e.g., via one or more buses).

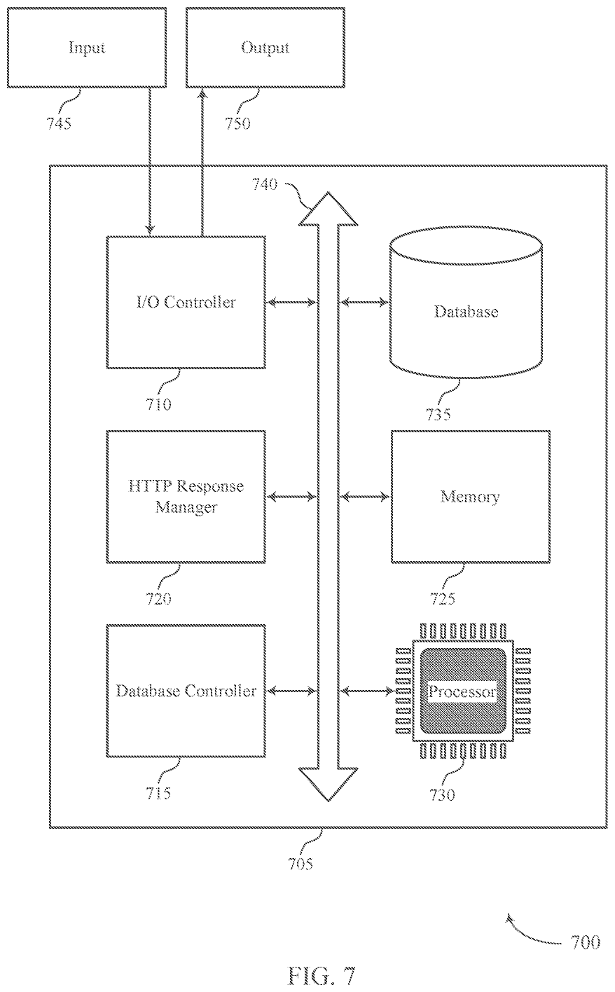

The input module 510 may manage input signals for the device 505. For example, the input module 510 may identify input signals based on an interaction with a modem, a keyboard, a mouse, a touchscreen, or a similar device. These input signals may be associated with user input or processing at other components or devices. In some cases, the input module 510 may utilize an operating system such as iOS®, ANDROID®, MS-DOS®, MS-WINDOWS®, OS/2®, UNIX®, LINUX®, or another known operating system to handle input signals. The input module 510 may send aspects of these input signals to other components of the device 505 for processing. For example, the input module 510 may transmit input signals to the HTTP response manager 520 to support declarative rendering of HTTP headers. In some cases, the input module 510 may be a component of an I/O controller 710 as described with reference to FIG. 7.

The output module 515 may manage output signals for the device 505. For example, the output module 515 may receive signals from other components of the device 505, such as the HTTP response manager 520, and may transmit these signals to other components or devices. In some examples, the output module 515 may transmit output signals for display in a user interface, for storage in a database or data store, for further processing at a server or server cluster, or for any other processes at any number of devices or systems. In some cases, the output module 515 may be a component of an I/O controller 710 as described with reference to FIG. 7.

For example, the HTTP response manager 520 may include a partial response reception component 525, a configuration retrieval component 530, a response generation component 535, a response transmission component 540, or any combination thereof. In some examples, the HTTP response manager 520, or various components thereof, may be configured to perform various operations (e.g., receiving, monitoring, transmitting) using or otherwise in cooperation with the input module 510, the output module 515, or both. For example, the HTTP response manager 520 may receive information from the input module 510, send information to the output module 515, or be integrated in combination with the input module 510, the output module 515, or both to receive information, transmit information, or perform various other operations as described herein.

The HTTP response manager 520 may support data processing in accordance with examples as disclosed herein. The partial response reception component 525 may be configured as or otherwise support a means for receiving a partial HTTP response message generated in response to an HTTP request message transmitted by a user device, the partial HTTP response message comprising an indication of an HTTP header configuration based at least in part on one or more security parameters associated with the HTTP request message. The configuration retrieval component 530 may be configured as or otherwise support a means for retrieving the HTTP header configuration based at least in part on the indication of the HTTP header configuration, wherein the HTTP header configuration indicates one or more HTTP header parameters and one or more header rendering actions associated with the one or more HTTP header parameters. The response generation component 535 may be configured as or otherwise support a means for generating a complete HTTP response message that comprises the partial HTTP response message modified by the one or more HTTP header parameters based at least in part on the one or more header rendering actions. The response transmission component 540 may be configured as or otherwise support a means for transmitting the complete HTTP response message to the user device.

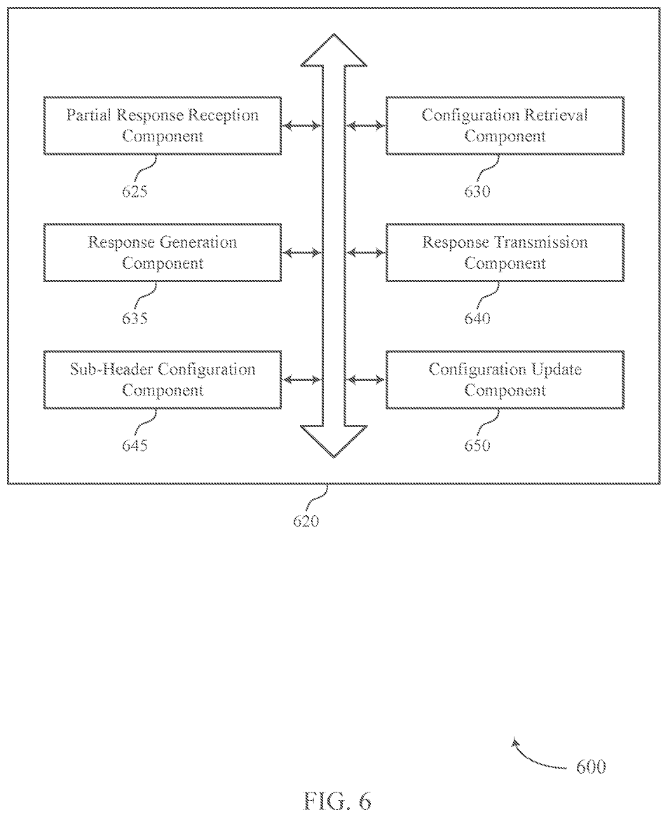

FIG. 6 shows a block diagram 600 of an HTTP response manager 620 that supports declarative rendering of HTTP headers in accordance with examples as provided herein. The HTTP response manager 620 may be an example of aspects of an HTTP response manager or an HTTP response manager 520, or both, as described herein. The HTTP response manager 620, or various components thereof, may be an example of means for performing various aspects of declarative rendering of HTTP headers as described herein. For example, the HTTP response manager 620 may include a partial response reception component 625, a configuration retrieval component 630, a response generation component 635, a response transmission component 640, a sub-header configuration component 645, a configuration update component 650, or any combination thereof. Each of these components may communicate, directly or indirectly, with one another (e.g., via one or more buses).

The HTTP response manager 620 may support data processing in accordance with examples as disclosed herein. The partial response reception component 625 may be configured as or otherwise support a means for receiving a partial HTTP response message generated in response to an HTTP request message transmitted by a user device, the partial HTTP response message comprising an indication of an HTTP header configuration based at least in part on one or more security parameters associated with the HTTP request message. The configuration retrieval component 630 may be configured as or otherwise support a means for retrieving the HTTP header configuration based at least in part on the indication of the HTTP header configuration, wherein the HTTP header configuration indicates one or more HTTP header parameters and one or more header rendering actions associated with the one or more HTTP header parameters. The response generation component 635 may be configured as or otherwise support a means for generating a complete HTTP response message that comprises the partial HTTP response message modified by the one or more HTTP header parameters based at least in part on the one or more header rendering actions. The response transmission component 640 may be configured as or otherwise support a means for transmitting the complete HTTP response message to the user device.

In some examples, the sub-header configuration component 645 may be configured as or otherwise support a means for identifying, based at least in part on the HTTP header configuration, one or more sub-header parameters associated with the one or more HTTP header parameters and one or more sub-header rendering actions associated with the one or more sub-header parameters, wherein the complete HTTP response message comprises the partial HTTP response message modified by the one or more sub-header parameters based at least in part on the one or more sub-header rendering actions.

In some examples, the one or more security parameters are associated with one or more page functions associated with the partial HTTP response message.

In some examples, the indication of the HTTP header configuration is included in the partial HTTP response message based at least in part on one or more cookies associated with the partial HTTP response message, one or more URLs associated with the partial HTTP response message, one or more tokens, a browser associated with the partial HTTP response message, or any combination thereof

In some examples, to support retrieving the HTTP header configuration, the configuration retrieval component 630 may be configured as or otherwise support a means for retrieving a default HTTP header configuration based at least in part on the indication of the HTTP header configuration comprising an indication of the default HTTP header configuration.

In some examples, the configuration update component 650 may be configured as or otherwise support a means for receiving an HTTP header configuration update request comprising an indication of one or more modifications to at least one of the one or more header rendering actions. In some examples, the configuration update component 650 may be configured as or otherwise support a means for modifying the one or more header rendering actions based at least in part on the HTTP header configuration update request.

In some examples, the indication of the HTTP header configuration comprises an HTTP header configuration identifier. In some examples, retrieving the HTTP header configuration comprises performing a matching process between the HTTP header configuration identifier and the HTTP header configuration.

In some examples, the one or more header rendering actions comprise a set action, a set-if-empty action, a merge action, an unset action, an add action, or any combination thereof

In some examples, the HTTP header configuration is stored in a markup file format.

FIG. 7 shows a diagram of a system 700 including a device 705 that supports declarative rendering of HTTP headers in accordance with examples as provided herein. The device 705 may be an example of or include the components of a device 505 as described herein. The device 705 may include components for bi-directional data communications including components for transmitting and receiving communications, such as an HTTP response manager 720, an I/O controller 710, a database controller 715, a memory 725, a processor 730, and a database 735. These components may be in electronic communication or otherwise coupled (e.g., operatively, communicatively, functionally, electronically, electrically) via one or more buses (e.g., a bus 740).

The I/O controller 710 may manage input signals 745 and output signals 750 for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. In other cases, the I/O controller 710 may represent or interact with a modem, a keyboard, a mouse, a touchscreen, or a similar device. In some cases, the I/O controller 710 may be implemented as part of a processor 730. In some examples, a user may interact with the device 705 via the I/O controller 710 or via hardware components controlled by the I/O controller 710.

The database controller 715 may manage data storage and processing in a database 735. In some cases, a user may interact with the database controller 715. In other cases, the database controller 715 may operate automatically without user interaction. The database 735 may be an example of a single database, a distributed database, multiple distributed databases, a data store, a data lake, or an emergency backup database.

Memory 725 may include random-access memory (RAM) and ROM. The memory 725 may store computer-readable, computer-executable software including instructions that, when executed, cause the processor 730 to perform various functions described herein. In some cases, the memory 725 may contain, among other things, a BIOS which may control basic hardware or software operation such as the interaction with peripheral components or devices.

The processor 730 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 730 may be configured to operate a memory array using a memory controller. In other cases, a memory controller may be integrated into the processor 730. The processor 730 may be configured to execute computer-readable instructions stored in a memory 725 to perform various functions (e.g., functions or tasks supporting declarative rendering of HTTP headers).

The HTTP response manager 720 may support data processing in accordance with examples as disclosed herein. For example, the HTTP response manager 720 may be configured as or otherwise support a means for receiving a partial HTTP response message generated in response to an HTTP request message transmitted by a user device, the partial HTTP response message comprising an indication of an HTTP header configuration based at least in part on one or more security parameters associated with the HTTP request message. The HTTP response manager 720 may be configured as or otherwise support a means for retrieving the HTTP header configuration based at least in part on the indication of the HTTP header configuration, wherein the HTTP header configuration indicates one or more HTTP header parameters and one or more header rendering actions associated with the one or more HTTP header parameters. The HTTP response manager 720 may be configured as or otherwise support a means for generating a complete HTTP response message that comprises the partial HTTP response message modified by the one or more HTTP header parameters based at least in part on the one or more header rendering actions. The HTTP response manager 720 may be configured as or otherwise support a means for transmitting the complete HTTP response message to the user device.

By including or configuring the HTTP response manager 720 in accordance with examples as described herein, the device 705 may support techniques for improved communication reliability, reduced latency, improved user experience related to reduced processing, reduced power consumption, more efficient utilization of communication resources, improved coordination between devices, longer battery life, improved utilization of processing capability, or a combination thereof , or a combination thereof

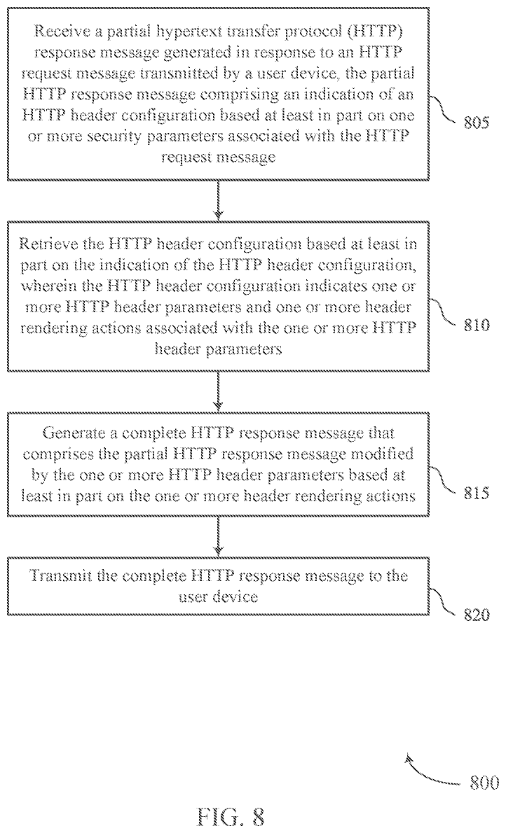

FIG. 8 shows a flowchart illustrating a method 800 that supports declarative rendering of HTTP headers in accordance with examples as provided herein. The operations of the method 800 may be implemented by an application server or its components as described herein. For example, the operations of the method 800 may be performed by an application server as described with reference to FIGS. 1 through 7. In some examples, an application server may execute a set of instructions to control the functional elements of the application server to perform the described functions. Additionally or alternatively, the application server may perform aspects of the described functions using special-purpose hardware.

At 805, the method may include receiving a partial HTTP response message generated in response to an HTTP request message transmitted by a user device, the partial HTTP response message comprising an indication of an HTTP header configuration based at least in part on one or more security parameters associated with the HTTP request message. The operations of 805 may be performed in accordance with examples as disclosed herein. In some examples, aspects of the operations of 805 may be performed by a partial response reception component 625 as described with reference to FIG. 6.

At 810, the method may include retrieving the HTTP header configuration based at least in part on the indication of the HTTP header configuration, wherein the HTTP header configuration indicates one or more HTTP header parameters and one or more header rendering actions associated with the one or more HTTP header parameters. The operations of 810 may be performed in accordance with examples as disclosed herein. In some examples, aspects of the operations of 810 may be performed by a configuration retrieval component 630 as described with reference to FIG. 6.

At 815, the method may include generating a complete HTTP response message that comprises the partial HTTP response message modified by the one or more HTTP header parameters based at least in part on the one or more header rendering actions. The operations of 815 may be performed in accordance with examples as disclosed herein. In some examples, aspects of the operations of 815 may be performed by a response generation component 635 as described with reference to FIG. 6.

At 820, the method may include transmitting the complete HTTP response message to the user device. The operations of 820 may be performed in accordance with examples as disclosed herein. In some examples, aspects of the operations of 820 may be performed by a response transmission component 640 as described with reference to FIG. 6.

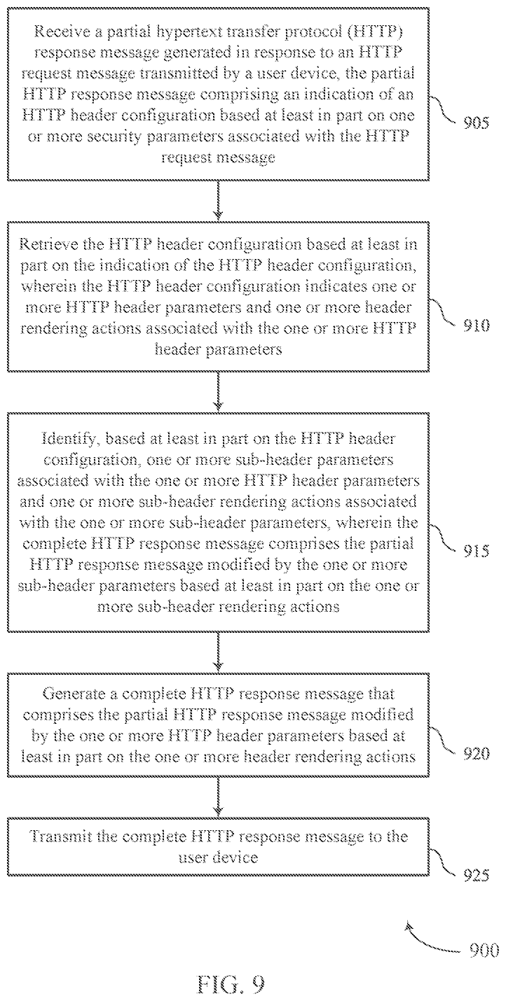

FIG. 9 shows a flowchart illustrating a method 900 that supports declarative rendering of HTTP headers in accordance with examples as provided herein. The operations of the method 900 may be implemented by an application server or its components as described herein. For example, the operations of the method 900 may be performed by an application server as described with reference to FIGS. 1 through 7. In some examples, an application server may execute a set of instructions to control the functional elements of the application server to perform the described functions. Additionally or alternatively, the application server may perform aspects of the described functions using special-purpose hardware.

At 905, the method may include receiving a partial HTTP response message generated in response to an HTTP request message transmitted by a user device, the partial HTTP response message comprising an indication of an HTTP header configuration based at least in part on one or more security parameters associated with the HTTP request message. The operations of 905 may be performed in accordance with examples as disclosed herein. In some examples, aspects of the operations of 905 may be performed by a partial response reception component 625 as described with reference to FIG. 6.

At 910, the method may include retrieving the HTTP header configuration based at least in part on the indication of the HTTP header configuration, wherein the HTTP header configuration indicates one or more HTTP header parameters and one or more header rendering actions associated with the one or more HTTP header parameters. The operations of 910 may be performed in accordance with examples as disclosed herein. In some examples, aspects of the operations of 910 may be performed by a configuration retrieval component 630 as described with reference to FIG. 6.

At 915, the method may include identifying, based at least in part on the HTTP header configuration, one or more sub-header parameters associated with the one or more HTTP header parameters and one or more sub-header rendering actions associated with the one or more sub-header parameters, wherein the complete HTTP response message comprises the partial HTTP response message modified by the one or more sub-header parameters based at least in part on the one or more sub-header rendering actions. The operations of 915 may be performed in accordance with examples as disclosed herein. In some examples, aspects of the operations of 915 may be performed by a sub-header configuration component 645 as described with reference to FIG. 6.

At 920, the method may include generating a complete HTTP response message that comprises the partial HTTP response message modified by the one or more HTTP header parameters based at least in part on the one or more header rendering actions. The operations of 920 may be performed in accordance with examples as disclosed herein. In some examples, aspects of the operations of 920 may be performed by a response generation component 635 as described with reference to FIG. 6.

At 925, the method may include transmitting the complete HTTP response message to the user device. The operations of 925 may be performed in accordance with examples as disclosed herein. In some examples, aspects of the operations of 925 may be performed by a response transmission component 640 as described with reference to FIG. 6.

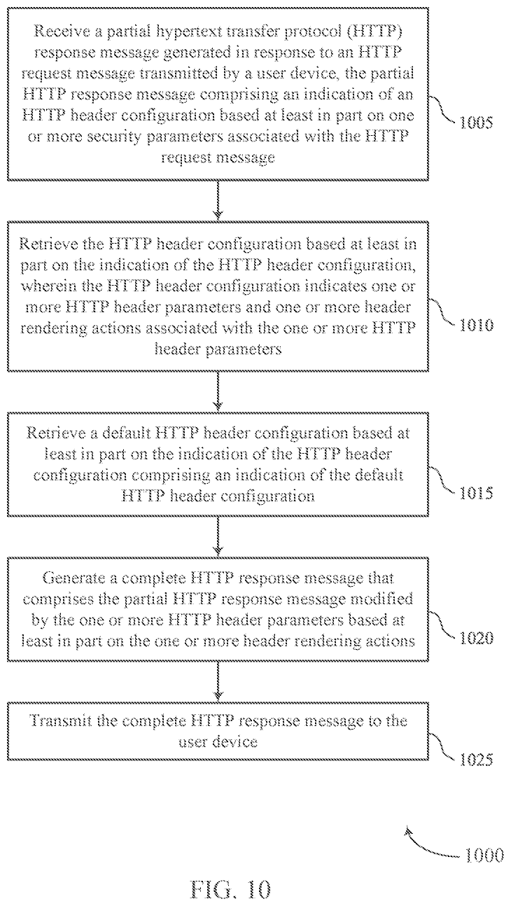

FIG. 10 shows a flowchart illustrating a method 1000 that supports declarative rendering of HTTP headers in accordance with examples as provided herein. The operations of the method 1000 may be implemented by an application server or its components as described herein. For example, the operations of the method 1000 may be performed by an application server as described with reference to FIGS. 1 through 7. In some examples, an application server may execute a set of instructions to control the functional elements of the application server to perform the described functions. Additionally or alternatively, the application server may perform aspects of the described functions using special-purpose hardware.

At 1005, the method may include receiving a partial HTTP response message generated in response to an HTTP request message transmitted by a user device, the partial HTTP response message comprising an indication of an HTTP header configuration based at least in part on one or more security parameters associated with the HTTP request message. The operations of 1005 may be performed in accordance with examples as disclosed herein. In some examples, aspects of the operations of 1005 may be performed by a partial response reception component 625 as described with reference to FIG. 6.

At 1010, the method may include retrieving the HTTP header configuration based at least in part on the indication of the HTTP header configuration, wherein the HTTP header configuration indicates one or more HTTP header parameters and one or more header rendering actions associated with the one or more HTTP header parameters. The operations of 1010 may be performed in accordance with examples as disclosed herein. In some examples, aspects of the operations of 1010 may be performed by a configuration retrieval component 630 as described with reference to FIG. 6.

At 1015, the method may include retrieving a default HTTP header configuration based at least in part on the indication of the HTTP header configuration comprising an indication of the default HTTP header configuration. The operations of 1015 may be performed in accordance with examples as disclosed herein. In some examples, aspects of the operations of 1015 may be performed by a configuration retrieval component 630 as described with reference to FIG. 6.

At 1020, the method may include generating a complete HTTP response message that comprises the partial HTTP response message modified by the one or more HTTP header parameters based at least in part on the one or more header rendering actions. The operations of 1020 may be performed in accordance with examples as disclosed herein. In some examples, aspects of the operations of 1020 may be performed by a response generation component 635 as described with reference to FIG. 6.

At 1025, the method may include transmitting the complete HTTP response message to the user device. The operations of 1025 may be performed in accordance with examples as disclosed herein. In some examples, aspects of the operations of 1025 may be performed by a response transmission component 640 as described with reference to FIG. 6.

A method for data processing is described. The method may include receiving a partial hypertext transfer protocol (HTTP) response message generated in response to an HTTP request message transmitted by a user device, the partial HTTP response message comprising an indication of an HTTP header configuration based at least in part on one or more security parameters associated with the HTTP request message, retrieving the HTTP header configuration based at least in part on the indication of the HTTP header configuration, wherein the HTTP header configuration indicates one or more HTTP header parameters and one or more header rendering actions associated with the one or more HTTP header parameters, generating a complete HTTP response message that comprises the partial HTTP response message modified by the one or more HTTP header parameters based at least in part on the one or more header rendering actions, and transmitting the complete HTTP response message to the user device.

An apparatus for data processing is described. The apparatus may include a processor, memory coupled with the processor, and instructions stored in the memory. The instructions may be executable by the processor to cause the apparatus to receive a partial hypertext transfer protocol (HTTP) response message generated in response to an HTTP request message transmitted by a user device, the partial HTTP response message comprising an indication of an HTTP header configuration based at least in part on one or more security parameters associated with the HTTP request message, retrieve the HTTP header configuration based at least in part on the indication of the HTTP header configuration, wherein the HTTP header configuration indicates one or more HTTP header parameters and one or more header rendering actions associated with the one or more HTTP header parameters, generate a complete HTTP response message that comprises the partial HTTP response message modified by the one or more HTTP header parameters based at least in part on the one or more header rendering actions, and transmit the complete HTTP response message to the user device.

Another apparatus for data processing is described. The apparatus may include means for receiving a partial hypertext transfer protocol (HTTP) response message generated in response to an HTTP request message transmitted by a user device, the partial HTTP response message comprising an indication of an HTTP header configuration based at least in part on one or more security parameters associated with the HTTP request message, means for retrieving the HTTP header configuration based at least in part on the indication of the HTTP header configuration, wherein the HTTP header configuration indicates one or more HTTP header parameters and one or more header rendering actions associated with the one or more HTTP header parameters, means for generating a complete HTTP response message that comprises the partial HTTP response message modified by the one or more HTTP header parameters based at least in part on the one or more header rendering actions, and means for transmitting the complete HTTP response message to the user device.

A non-transitory computer-readable medium storing code for data processing is described. The code may include instructions executable by a processor to receive a partial hypertext transfer protocol (HTTP) response message generated in response to an HTTP request message transmitted by a user device, the partial HTTP response message comprising an indication of an HTTP header configuration based at least in part on one or more security parameters associated with the HTTP request message, retrieve the HTTP header configuration based at least in part on the indication of the HTTP header configuration, wherein the HTTP header configuration indicates one or more HTTP header parameters and one or more header rendering actions associated with the one or more HTTP header parameters, generate a complete HTTP response message that comprises the partial HTTP response message modified by the one or more HTTP header parameters based at least in part on the one or more header rendering actions, and transmit the complete HTTP response message to the user device.

Some examples of the method, apparatuses, and non-transitory computer-readable medium described herein may further include operations, features, means, or instructions for identifying, based at least in part on the HTTP header configuration, one or more sub-header parameters associated with the one or more HTTP header parameters and one or more sub-header rendering actions associated with the one or more sub-header parameters, wherein the complete HTTP response message comprises the partial HTTP response message modified by the one or more sub-header parameters based at least in part on the one or more sub-header rendering actions.

In some examples of the method, apparatuses, and non-transitory computer-readable medium described herein, the one or more security parameters may be associated with one or more page functions associated with the partial HTTP response message.

In some examples of the method, apparatuses, and non-transitory computer-readable medium described herein, the indication of the HTTP header configuration may be included in the partial HTTP response message based at least in part on one or more cookies associated with the partial HTTP response message, one or more uniform resource locators (URLs) associated with the partial HTTP response message, one or more tokens, a browser associated with the partial HTTP response message, or any combination thereof.

In some examples of the method, apparatuses, and non-transitory computer-readable medium described herein, retrieving the HTTP header configuration may include operations, features, means, or instructions for retrieving a default HTTP header configuration based at least in part on the indication of the HTTP header configuration comprising an indication of the default HTTP header configuration.

Some examples of the method, apparatuses, and non-transitory computer-readable medium described herein may further include operations, features, means, or instructions for receiving an HTTP header configuration update request comprising an indication of one or more modifications to at least one of the one or more header rendering actions and modifying the one or more header rendering actions based at least in part on the HTTP header configuration update request.

In some examples of the method, apparatuses, and non-transitory computer-readable medium described herein, the indication of the HTTP header configuration comprises an HTTP header configuration identifier and retrieving the HTTP header configuration comprises performing a matching process between the HTTP header configuration identifier and the HTTP header configuration.

In some examples of the method, apparatuses, and non-transitory computer-readable medium described herein, the one or more header rendering actions comprise a set action, a set-if-empty action, a merge action, an unset action, an add action, or any combination thereof

In some examples of the method, apparatuses, and non-transitory computer-readable medium described herein, the HTTP header configuration may be stored in a markup file format.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

1. A method for data processing, comprising:
receiving a partial hypertext transfer protocol (HTTP) response message generated in response to an HTTP request message transmitted by a user device, the partial HTTP response message comprising an identifier of an HTTP header configuration based at least in part on one or more security parameters associated with the HTTP request message;
retrieving the HTTP header configuration based at least in part on the identifier of the HTTP header configuration comprised in the partial HTTP response message, wherein the HTTP header configuration indicates one or more HTTP header parameters and one or more header rendering actions associated with the one or more HTTP header parameters;
generating a complete HTTP response message that comprises the partial HTTP response message modified by the one or more HTTP header parameters based at least in part on the one or more header rendering actions; and
transmitting the complete HTTP response message to the user device.

2. The method of claim 1, further comprising:
identifying, based at least in part on the HTTP header configuration, one or more sub-header parameters associated with the one or more HTTP header parameters and one or more sub-header rendering actions associated with the one or more sub-header parameters, wherein the complete HTTP response message comprises the partial HTTP response message modified by the one or more sub-header parameters based at least in part on the one or more sub-header rendering actions.

3. The method of claim 1, wherein the one or more security parameters are associated with one or more page functions associated with the partial HTTP response message.

4. The method of claim 1, wherein the identifier of the HTTP header configuration is included in the partial HTTP response message based at least in part on one or more cookies associated with the partial HTTP response message, one or more uniform resource locators (URLs) associated with the partial HTTP response message, one or more tokens, a browser associated with the partial HTTP response message, or any combination thereof.

5. The method of claim 1, wherein retrieving the HTTP header configuration comprises:
retrieving a default HTTP header configuration based at least in part on the identifier of the HTTP header configuration comprising an identifier of the default HTTP header configuration.

6. The method of claim 1, further comprising:
receiving an HTTP header configuration update request comprising an indication of one or more modifications to at least one of the one or more header rendering actions; and
modifying the one or more header rendering actions based at least in part on the HTTP header configuration update request.

7. The method of claim 1, wherein:
retrieving the HTTP header configuration comprises performing a matching process between the HTTP header configuration identifier and the HTTP header configuration.

8. The method of claim 1, wherein the one or more header rendering actions comprise a set action, a set-if-empty action, a merge action, an unset action, an add action, or any combination thereof.

9. The method of claim 1, wherein the HTTP header configuration is stored in a markup file format.

10. An apparatus for data processing, comprising:
a processor;
memory coupled with the processor; and
instructions stored in the memory and executable by the processor to cause the apparatus to:
receive a partial hypertext transfer protocol (HTTP) response message generated in response to an HTTP request message transmitted by a user device, the partial HTTP response message comprising an identifier of an HTTP header configuration based at least in part on one or more security parameters associated with the HTTP request message;
retrieve the HTTP header configuration based at least in part on the identifier of the HTTP header configuration comprised in the partial HTTP response message, wherein the HTTP header configuration indicates one or more HTTP header parameters and one or more header rendering actions associated with the one or more HTTP header parameters;
generate a complete HTTP response message that comprises the partial HTTP response message modified by the one or more HTTP header parameters based at least in part on the one or more header rendering actions; and
transmit the complete HTTP response message to the user device.

11. The apparatus of claim 10, wherein the instructions are further executable by the processor to cause the apparatus to:
identify, based at least in part on the HTTP header configuration, one or more sub-header parameters associated with the one or more HTTP header parameters and one or more sub-header rendering actions associated with the one or more sub-header parameters, wherein the complete HTTP response message comprises the partial HTTP response message modified by the one or more sub-header parameters based at least in part on the one or more sub-header rendering actions.

12. The apparatus of claim 10, wherein the one or more security parameters are associated with one or more page functions associated with the partial HTTP response message.

13. The apparatus of claim 10, wherein the identifier of the HTTP header configuration is included in the partial HTTP response message based at least in part on one or more cookies associated with the partial HTTP response message, one or more uniform resource locators (URLs) associated with the partial HTTP response message, one or more tokens, a browser associated with the partial HTTP response message, or any combination thereof.

14. The apparatus of claim 10, wherein the instructions to retrieve the HTTP header configuration are executable by the processor to cause the apparatus to:
retrieve a default HTTP header configuration based at least in part on the identifier of the HTTP header configuration comprising an identifier of the default HTTP header configuration.

15. The apparatus of claim 10, wherein the instructions are further executable by the processor to cause the apparatus to:
receive an HTTP header configuration update request comprising an indication of one or more modifications to at least one of the one or more header rendering actions; and
modify the one or more header rendering actions based at least in part on the HTTP header configuration update request.

16. The apparatus of claim 10, wherein:
retrieving the HTTP header configuration comprises performing a matching process between the HTTP header configuration identifier and the HTTP header configuration.

17. The apparatus of claim 10, wherein the one or more header rendering actions comprise a set action, a set-if-empty action, a merge action, an unset action, an add action, or any combination thereof.

18. The apparatus of claim 10, wherein the HTTP header configuration is stored in a markup file format.

19. A non-transitory computer-readable medium storing code for data processing, the code comprising instructions executable by a processor to:
receive a partial hypertext transfer protocol (HTTP) response message generated in response to an HTTP request message transmitted by a user device, the partial HTTP response message comprising an identifier of an HTTP header configuration based at least in part on one or more security parameters associated with the HTTP request message;
retrieve the HTTP header configuration based at least in part on the identifier of the HTTP header configuration comprised in the partial HTTP response message, wherein the HTTP header configuration indicates one or more HTTP header parameters and one or more header rendering actions associated with the one or more HTTP header parameters;
generate a complete HTTP response message that comprises the partial HTTP response message modified by the one or more HTTP header parameters based at least in part on the one or more header rendering actions; and
transmit the complete HTTP response message to the user device.

20. The non-transitory computer-readable medium of claim 19, wherein the instructions are further executable by the processor to:
identify, based at least in part on the HTTP header configuration, one or more sub-header parameters associated with the one or more HTTP header parameters and one or more sub-header rendering actions associated with the one or more sub-header parameters, wherein the complete HTTP response message comprises the partial HTTP response message modified by the one or more sub-header parameters based at least in part on the one or more sub-header rendering actions.
